(19) United States
(12) Patent Application Publication
(10) Pub. No.: US 2024/0064666 A1
(43) Pub. Date: Feb. 22, 2024

(54) METHODS AND PROCEDURES FOR SYNCHRONIZATION AND OVER-THE-AIR COMPUTATION

(71) Applicant: UNIVERSITY OF SOUTH CAROLINA, COLUMBIA, SC (US)

(72) Inventor: ALPHAN SAHIN, COLUMBIA, SC (US)

(21) Appl. No.: 18/446,680

(22) Filed: Aug. 9, 2023

Related U.S. Application Data
(60) Provisional application No. 63/505,835, filed on Jun. 2, 2023.
(60) Provisional application No. 63/396,351, filed on Aug. 9, 2022.

(51) Int. Cl. H04W 56/00; G06N 20/00; H04B 1/00

(52) U.S. Cl. CPC H04W 56/001; G06N 20/00; H04B 1/0003

(57) ABSTRACT

A general-purpose synchronization method allows a set of software-defined radios (SDRs) to transmit or receive any in-phase/quadrature (IQ) data with precise timings while maintaining the baseband processing in the corresponding companion computers (CCs). The presently disclosed method relies on the detection of a synchronization waveform in both receive and transmit directions and controlling the direct memory access (DMA) blocks jointly with the processing system. By implementing this synchronization method on a set of low-cost SDRs, the performance of frequency-shift keying (FSK)-based majority vote (MV) (FSK-MV) is demonstrated. Stated another way, the present disclosure relates to an over-the-air computation (OAC) scheme for federated edge learning (FEEL), and corresponding procedures. Demonstration shows that test accuracy can reach more than 95% for homogeneous and heterogeneous data distributions without using channel state information at the edge devices (EDs).

### PRIORITY CLAIMS

The present application claims the benefit of priority of U.S. Provisional Patent Application No. 63/396,351, filed Aug. 9, 2022, and the benefit of priority of U.S. Provisional Patent Application No. 63/505,835, filed Jun. 2, 2023, both of which are titled Methods And Procedures For Synchronization And Over-The-Air Computation, and both of which are fully incorporated herein by reference for all purposes.

### BACKGROUND OF THE PRESENTLY DISCLOSED SUBJECT MATTER

### I. Introduction

Over-the-air computation (OAC) leverages the signal superposition property of wireless multiple-access channels to compute a nomographic function [1]. It has recently gained major attention to reduce the per-round communication latency that linearly increases with the number of edge devices (EDs) for federated edge learning (FEEL), i.e., an implementation of federated learning (FL) in a wireless network [2], [3]. Despite its merit, an OAC scheme may require the EDs to start their transmissions synchronously with high accuracy [4], which can impose stringent requirements for the underlying mechanisms. In a practical network, time synchronization can be maintained via an external timing reference such as the Global Positioning System (GPS) (see [5] and the references therein), a triggering mechanism as in IEEE 802.11 [6], or well designed synchronization procedures over random-access and control channels as in cellular networks [7].

However, while using a GPS-based solution can be costly and not suitable for indoor applications, the implementations of a trigger-based synchronization or some synchronization protocols may not be self-sufficient. This is because an entire baseband besides the synchronization blocks may need to be implemented as a hard-coded block to satisfy the timing constraints. On the other hand, when a software-defined radio (SDR) is used as an I/O peripheral connected to a companion computer (CC) for flexible baseband processing, the transmission/reception instants are subject to a large jitter due to the underlying protocols (e.g., USB, TCP/IP) for the communication between the CC and the SDR. Hence, it is not trivial to use SDRs to test an OAC scheme in practice.

In the state-of-the-art, proof-of-concept OAC demonstrations are particularly in the area of wireless sensor networks. For example, in [8], a statistical OAC is implemented with twenty-one RFID tags to compute the percentages of the activated classes that encode various temperature ranges. A trigger signal is used to achieve time synchronization across the RFIDs. In [9], Goldenbaum and Stańczak's scheme is implemented with three SDRs emulating eleven sensor nodes and a fusion center. The arithmetic and geometric mean of the sensor readings are computed over a 5 MHz signal. The time synchronization across the sensor nodes is maintained based on a trigger signal and the disclosed method is implemented in a field-programmable gate array (FPGA). A calibration procedure is also discussed to ensure amplitude alignment at the fusion center. In [11], the summation is evaluated with a testbed that involves three SDRs as transmitters and an SDR as a receiver. The scheme used in this setup is based on channel inversion. However, the details related to the synchronization are not provided.

Over-the-air computation (OAC) reduces the communication latency that linearly increases with the number of devices in a wireless network for machine learning applications. Despite its merit, an OAC scheme may require the radios to start their transmissions synchronously with high accuracy, which can impose stringent requirements for the underlying mechanisms. On the other hand, when SDRs are used as radios for this application, the synchronization is hard to maintain.

In a practical network, time synchronization can be maintained via an external timing reference such as the Global Positioning System (GPS), a triggering mechanism as in IEEE 802.11, or well-designed synchronization procedures over random-access and control channels as in cellular networks. However, while using a GPS-based solution can be costly and unsuitable for indoor applications, the implementations of a trigger-based synchronization or some synchronization protocols may not be self-sufficient because an entire baseband besides the synchronization blocks may need to be implemented as a hard-coded block to satisfy the timing constraints. On the other hand, when an SDR is used as an I/O peripheral connected to a CC for flexible baseband processing, the transmission/reception instants are subject to a large jitter due to the underlying protocols (e.g., USB, TCP/IP) for the communication between the CC and the SDR. Hence, it is not trivial to use SDRs to test an OAC scheme in practice. Also, the procedures for OAC are needed and it is not actually clear how it will work in a practical network.

Generally speaking, there is no widely known OAC scheme which has been demonstrated in practice for FEEL. The presently disclosed subject matter addresses such challenges, and addresses this gap and introduce a synchronization method suitable for SDRs.

### SUMMARY OF THE PRESENTLY DISCLOSED SUBJECT MATTER

Aspects and advantages of the presently disclosed subject matter will be set forth in part in the following description, or may be apparent from the description, or may be learned through practice of the presently disclosed subject matter.

Broadly speaking, the presently disclosed subject matter relates to methods and procedures for synchronization and over-the-air computation.

Another presently disclosed broader object is to provide general-purpose synchronization methodology.

Yet another present goal is to provide methodologies and procedures which enable an SDR-based network to realize over-the-air computation (OAC) for machine learning applications in a reliable way.

More particularly, it is a present object to provide general-purpose synchronization methodology which allows a set of software-defined radios (SDRs) to transmit or receive any in-phase/quadrature (IQ) data with precise timings while maintaining the baseband processing in the corresponding companion computers (CCs).

Further, for at least some embodiments, presently disclosed methodology relies on the detection of a synchronization waveform in both receive and transmit directions. For some such embodiments, the direct memory access (DMA) blocks are controlled jointly with the processing system.

Still further, by implementing presently disclosed synchronization methodology for some embodiments on a set of low-cost SDRs, the performance of frequency-shift keying (FSK)-based majority vote (MV) (FSK-MV) is demonstrated. Stated another way, the present disclosure relates to an over-the-air computation (OAC) scheme for federated edge learning (FEEL), and corresponding procedures. Demonstration shows that test accuracy can reach more than 95% for homogeneous and heterogeneous data distributions without using channel state information at the edge devices (EDs).

Stated yet another way, the presently disclosed general-purpose synchronization methodology for some embodiments allows a set of software-defined radios (SDRs) to transmit or receive any in-phase/quadrature (IQ) data with precise timings while maintaining the baseband processing in the corresponding companion computers (CCs). The disclosed method for some such embodiments relies on the detection of a synchronization waveform in both receive and transmit directions and on controlling the direct memory access (DMA) blocks jointly with the processing system. By implementing this synchronization method on a set of low-cost SDRs, we demonstrate the performance of frequency-shift keying (FSK)-based majority vote (MV) (FSK-MV), i.e., an over-the-air computation (OAC) scheme for federated edge learning (FEEL) and introduce the corresponding procedures.

Still further, the presently disclosed synchronization method for some embodiments enables low-cost SDR to be time-synchronous without using GPS or some additional circuitry. The presently disclosed procedures in some such embodiments enable OAC in practice by describing the alignment, calibration, and computation signals.

One presently disclosed exemplary methodology preferably relates to an over-the-air computation (OAC) methodology for federated edge learning (FEEL) without using channel state information (CSI) at a plurality of edge devices (EDs) or at an edge server (ES). Such methodology preferably may comprise a distributed machine-learning model to be trained with the update vectors received at an edge server (ES) as transmitted from a plurality of edge devices (EDs); one or more processors; and one or more non-transitory computer-readable media that store instructions that, when executed by the one or more processors, cause the one or more processors to perform operations. Such operations preferably may comprise transmitting local update vectors as votes from each respective of the plurality of edge devices (EDs) via a wireless multiple access channel, receiving the superposed local updates at the ES, determining the majority vote (MV) for each element of the update vector at the ES with an energy detector, and inputting the MVs into the machine-learning model to be updated. Further, the plurality of EDs and the ES preferably each respectively comprise a software-defined radio (SDR) using a general purpose synchronization method between the ES and each respective ED which relies on the detection of a synchronization waveform in both receive and transmit directions.

It is to be understood from the complete disclosure herewith that the presently disclosed subject matter equally relates to both methodology and corresponding and/or related apparatus.

One presently disclosed exemplary embodiment relates to an over-the-air computation (OAC) system for federated edge learning (FEEL) without using channel state information (CSI) at a plurality of edge devices (EDs) or at an edge server (ES). Such system preferably comprises a machine-learning model training to process data received at an edge server (ES) as transmitted from a plurality of edge devices (EDs); one or more processors; and one or more non-transitory computer-readable media that store instructions that, when executed by the one or more processors, cause the one or more processors to perform operations. Such operations preferably comprise transmitting local update vectors as votes from each respective of the plurality of edge devices (EDs) via a wireless multiple access channel, receiving the superposed local updates at the ES, determining the majority vote (MV) for each element of the update vector at the ES with an energy detector, and inputting the MVs into the machine-learning model to be updated. The plurality of EDs and the ES preferably each respectively comprise a software-defined radio (SDR) using a general purpose synchronization method between the ES and each respective ED which relies on the detection of a synchronization waveform in both receive and transmit directions.

The market impact of the presently disclosed subject matter is potentially large in size as it is related to both commercial wireless and AI technologies. It could, for example, be useful for artificial intelligence technologies over wireless or sensor networks, 5G and beyond, 6G wireless standardization, and IEEE 802.11 Wi-Fi. Recently, IEEE 802.11 has formed a Topic Interest Group, where distributed learning over a wireless network has been mentioned:

(https://mentor.ieee.org/802.11/documents?is_dcn=DCN%2C%20Title%2C%20Author %20or%20Affiliation&is_group=aiml)

Other example aspects of the present disclosure are directed to systems, apparatus, tangible, non-transitory computer-readable media, user interfaces, memory devices, and electronic smart devices or the like. To implement methodology and technology herewith, one or more processors may be provided, programmed to perform the steps and functions as called for by the presently disclosed subject matter, as will be understood by those of ordinary skill in the art.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the Figures or stated in the detailed description of such Figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

### BRIEF DESCRIPTION OF THE FIGURES

A full and enabling disclosure of the presently disclosed subject matter, including the best mode thereof, directed to one of ordinary skill in the art, is set forth in the specification, which makes reference to the appended Figures, in which:

FIG. 1(a) illustrates a diagram representing an exemplary scenario where K edge devices (EDs) for federated edge learning (FEEL) transmit a set of complex-valued vectors;

FIG. 1(b) illustrates an exemplary block diagram of representative signal processing blocks in accordance with presently disclosed methodology;

FIG. 1(c) illustrates a synchronization chart showing exemplary timing sequences and corresponding procedure for exemplary synchronous communications in accordance with presently disclosed subject matter;

FIG. 1(d) diagrammatically illustrates exemplary implemented IP in accordance with presently disclosed subject matter;

FIG. 2(a) represents an example of a timing chart illustrating an edge server (ES) transmitting a trigger signal, denoted by t_{cal}, along with x_{SYNC} as an aspect of a presently disclosed closed-loop calibration procedure;

FIG. 2(b) represents an example of a timing chart illustrating an edge server (ES) transmitting a feedback signal denoted by t_{feed} as an aspect of a presently disclosed closed-loop calibration procedure;

FIG. 3(a) represents an example of a timing chart illustrating the kth edge devices (EDs) responding to the received t_{grd} with X_{gradients,k}, ∀k, as an aspect of a presently disclosed procedure for frequency-shift keying (FSK)-based majority vote (MV) (FSK-MV) processing;

FIG. 3(b) represents an example of a timing chart illustrating the kth edge devices (EDs) transmitting xₘᵥ along with tₘᵥ as an aspect of a presently disclosed procedure for frequency-shift keying (FSK)-based majority vote (MV) (FSK-MV) processing;

FIG. 4 represents different fields used for a presently disclosed physical layer protocol data unit (PPDU) for signaling between EDs and ES;

FIGS. 5(a) and 5(b) are respective images of an exemplary experimental/confirmation set-up for practicing the presently disclosed subject matter for an exemplary learning task of handwritten-digit recognition with K=5 EDs and ES, where the exemplary arrangement is implemented with an NVIDIA Jetson Nano, a Microsoft Surface Pro 4, and six Analog Device Adalm Pluto software-defined radios (SDRs) for FEEL, with FIG. 5(a) showing an image of the ES with an NVIDIA Jetson Nano, and FIG. 5(b) showing an image of the five EDs with a Microsoft Surface Pro 4, and with an independent thread run for each SDR;

FIG. 6 illustrates a bar graph of the distribution of time synchronization error due to the imperfect clocks in Adalm Pluto SDRs (ED1 through ED5);

FIG. 7(a) graphically illustrates subcarrier index data to illustrate magnitudes of the channel frequency coefficients, between an ED and the ES, per absolute values;

FIG. 7(b) graphically illustrates subcarrier index data to illustrate magnitudes of the channel frequency coefficients (channel frequency response), between an ED and the ES, per phase changes; and

FIGS. 8(a)-8(h) respectively graphically represent test accuracy and training loss at each ED when the training is done without absentee votes ( [symbol] =0) and with absentee votes ( [symbol] =0.005), representing experiment results for the FEEL with the OAC scheme FSK-MV with/without absentee votes, with FIG. 8(a) graphing test accuracy for homogeneous data distribution without absentee votes, with FIG. 8(b) graphing test accuracy for homogeneous data distribution with absentee votes, with FIG. 8(c) graphing training loss for homogeneous data distribution without absentee votes, with FIG. 8(d) graphing training loss for homogeneous data distribution with absentee votes, with FIG. 8(e) graphing test accuracy for heterogeneous data distribution without absentee votes, with FIG. 8(f) graphing test accuracy for heterogeneous data distribution with absentee votes, with FIG. 8(g) graphing training loss for heterogeneous data distribution without absentee votes, with FIG. 8(h) graphing training loss for heterogeneous data distribution with absentee votes.

Repeat use of reference characters in the present specification and drawings is intended to represent the same or analogous features or elements or steps of the presently disclosed subject matter.

### DETAILED DESCRIPTION OF THE PRESENTLY DISCLOSED SUBJECT MATTER

It is to be understood by one of ordinary skill in the art that the present disclosure is a description of exemplary embodiments only, and is not intended as limiting the broader aspects of the disclosed subject matter. Each example is provided by way of explanation of the presently disclosed subject matter, not limitation of the presently disclosed subject matter. In fact, it will be apparent to those skilled in the art that various modifications and variations can be made in the presently disclosed subject matter without departing from the scope or spirit of the presently disclosed subject matter. For instance, features illustrated or described as part of one embodiment can be used with another embodiment to yield a still further embodiment. Thus, it is intended that the presently disclosed subject matter covers such modifications and variations as come within the scope of the appended claims and their equivalents.

The present disclosure is generally directed to methods and procedures for synchronization and over-the-air computation, such as providing general-purpose synchronization methodology. The present disclosure further relates to providing methodologies and procedures which enable an SDR-based network to realize over-the-air computation (OAC) for machine learning applications in a reliable way.

Presently disclosed subject matter relate in part to both (a) synchronization for CC-based baseband processing and (b) realization of OAC in practice for FEEL.

Synchronization for CC-based baseband processing: To maintain the time synchronization in an SDR-based network while maintaining the baseband in the CCs, we disclose a hard-coded block that is agnostic to the in-phase/quadrature (IQ) data desired to be communicated in the CC. We disclose the corresponding procedures, calibration, and synchronization waveform to address the hardware limitations.

Realization of OAC in practice for FEEL: We realize the disclosed method with an intellectual property (IP) core embedded into Adalm Pluto SDR. By using the presently disclosed synchronization method, we demonstrate the performance of frequency-shift keying (FSK)-based majority vote (MV) (FSK-MV) [12], [13], i.e., an OAC scheme for FEEL, for both homogeneous and heterogeneous data distribution scenarios. We also provide the corresponding procedures.

Notation: The complex and real numbers are denoted by [symbol] and R, respectively.

### II. Disclosed Synchronization Method

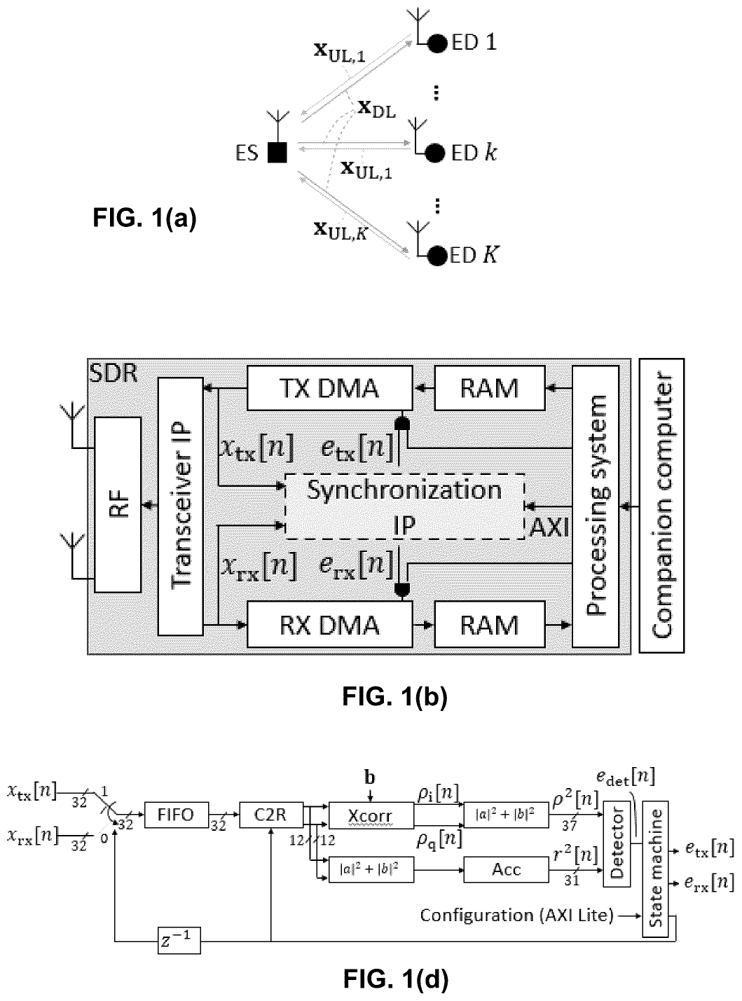

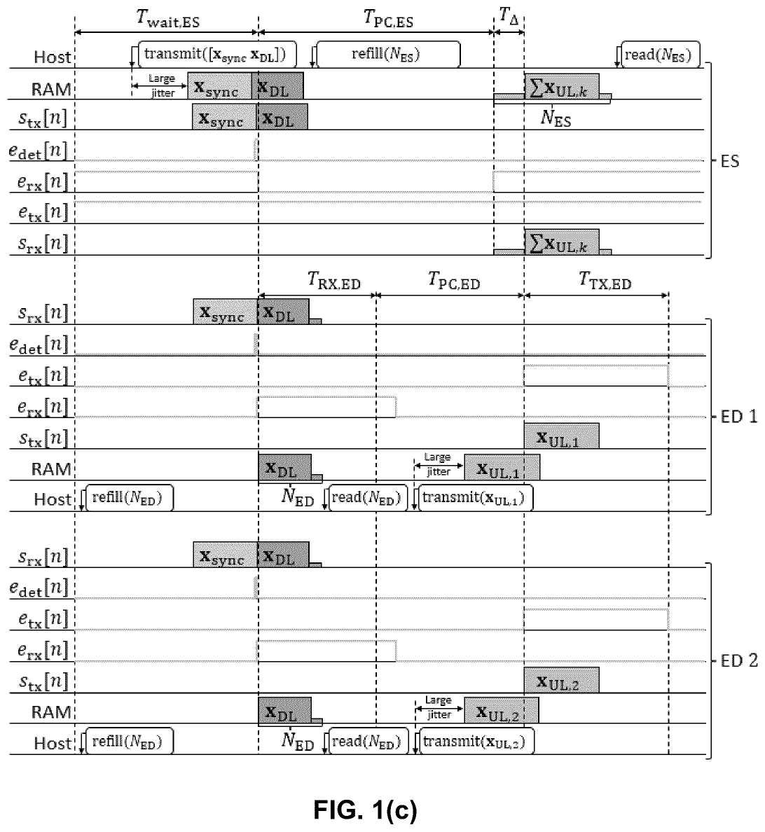

Consider a scenario where K EDs transmit a set of complex-valued vectors denoted by {x_{UL,k}∈ [symbol] ^{1×N}^{_{UL}}|k=1, . . . , K} to an edge server (ES) in the uplink (UL) in response to the vector x_{DL}∈ [symbol] ^{1×N}^{_{DL}} transmitted in the downlink (DL) from the ES, as illustrated in FIG. 1(a). Assume that the implementation of each ED (and the ES) is based on an SDR where the baseband processing is handled by a CC. Also, due to the communication protocol between the CC and the SDR, consider a large jitter (e.g., in the range of 100 ms) when the IQ data is transferred between the CC and the SDR. Given the large jitter, our goal is to ensure 1) the reception of the vector x_{DL} at the CC of each ED and 2) the reception of the superposed vector Σₖ₌₁ x_{UL,k} (i.e., implying synchronous transmissions for simultaneous reception) at the ES with precise timings (e.g., in the order of μs) while maintaining the baseband at the CCs.

To address the scenario above, the main strategy that we adopt is to separate any signal processing blocks that maintain the synchronization from the ones that do not need to be implemented under strict timing requirements so that the baseband can still be kept in the CC. Based on this strategy, we disclose a hard-coded block that is solely responsible for time synchronization. As shown in 1(b), the disclosed block jointly controls the TX direct-memory access (DMA) and the RX DMA with the processing system (PS) (e.g., Linux on the SDR) as a function of the detection of the synchronization waveform, denoted by x_{SYNC}, in the transmit or receive directions through the (active-high) digital signals eₜₓ [n]∈{0, 1} and eᵣₓ [n]∈{0, 1}, respectively. TX DMA and RX DMA are responsible for transferring the IQ samples from the random access memory (RAM) to the transceiver IP or vice versa, respectively. They are programmed by the PS, not by the block.

We define two modes for the block:

Mode 1: The default values of eₜₓ [n] and eᵣₓ [n] are 0, i.e., TX DMA and RX DMA cannot transfer the IQ samples. The block listens to the output of the transceiver IP (i.e., the IQ samples in the receive direction), denoted by xᵣₓ [n], and constantly searches for the synchronization waveform x_{SYNC}. If the vector x_{SYNC} is detected, it sequentially sets (eₜₓ [n], eᵣₓ [n])=(0, 1) for T_{RX} seconds to allow the RX DMA to move the received IQ samples to the RAM, sets (eₜₓ [n], eᵣₓ [n])=(0, 0) for T_{PC} seconds, and finally sets (eₜₓ [n], eᵣₓ [n])=(1, 0) for T_{TX} seconds to allow TX DMA to transfer the IQ samples from the RAM to the transceiver IP.

Mode 2: The default values of eₜₓ [n] and eᵣₓ [n] are 1, i.e., TX DMA and RX DMA can transfer the IQ samples. However, the block listens to the output of the TX DMA (the IQ samples in the transmit direction), denoted by xₜₓ [n]. It searches for the vector x_{SYNC}. If the vector x_{SYNC} is detected, it blocks the reception by setting eᵣₓ [n]=0 for T_{PC} seconds.

FIG. 1(a) illustrates a diagram representing an exemplary scenario where K edge devices (EDs) for federated edge learning (FEEL) transmit a set of complex-valued vectors. FIG. 1(b) illustrates an exemplary block diagram of representative signal processing blocks in accordance with presently disclosed methodology.

Now, assume that the SDRs at the EDs and the ES are equipped with the disclosed block and operate at Mode 1 and Mode 2, respectively. We disclose the following procedure, illustrated in FIG. 1(c), for synchronous communication:

FIG. 1(c) illustrates a synchronization chart showing exemplary timing sequences and corresponding procedure for exemplary synchronous communications in accordance with presently disclosed subject matter. While there is a large jitter for any transactions between the RAM and the CC, the disclosed block ensures precise timings for the reception of X_{DL} at the EDs, the synchronous transmissions of x_{UL,1} and x_{UL,2} to the ES, and the reception of the superposed signal.

FIG. 1(d) diagrammatically illustrates exemplary implemented IP in accordance with presently disclosed subject matter.

Step 1 (EDs): The CC at each ED executes a command (i.e., refill(N_{ED})) to fill the RAM with N_{ED} IQ samples in the receive direction for N_{ED}≥N_{DL}. Since RX DMA is disabled by the disclosed block at this point, the CC waits for the RX DMA to be enabled by the block.

Step 2 (ES): After the CC at the ES synthesizes the vector X_{DL}, it prepends x_{SYNC} to initiate the procedure. It writes [x_{SYNC} x_{DL}] to the RAM and starts TX DMA by executing a command (i.e., transmit([x_{SYNC} x_{DL}])). As soon as the block detects the vector x_{SYNC} in the transmit direction, it disables RX-DMA for T_{PC,ES} seconds. Subsequently, the CC issues another command, i.e., refill(N_{ES}), to fill its RAM in the receive direction, where N_{ES} is the number of IQ samples to be acquired. However, the reception does not start for T_{PC,ES} seconds due to the disabled RX DMA.

Step 3 (EDs): The transceiver IP at each ED receives [x_{SYNC} x_{DL}]. As soon as the block detects x_{SYNC}, it enables RX DMA. Assuming that T_{RX,ED} is large enough to acquire N_{ED} samples, the RX DMA transfers N_{ED} samples to the RAM as the PS requests for N_{ED} IQ samples on Step 1. The CC reads N_{ED} IQ samples in the RAM via a command, i.e., read(N_{ED}). As a result, X_{DL} is received with a precise timing.

Step 4 (EDs): The CC at the kth ED processes the vector X_{DL} and synthesizes x_{UL,k} as a response. It then writes x_{UL,k} to the RAM and initiates TX DMA by executing transmit([x_{SYNC} x_{DL}]) before the block enables the TX DMA to transfer. Hence, x_{UL,k} should be ready in the RAM within T_{RX,ED}+T_{PC,ED} seconds.

Step 5 (EDs): The disclosed block at the ED enables the TX-DMA for T_{TX,ED} seconds, where T_{TX,ED} is assumed to be large enough to transmit N_{UL} IQ samples. At this point, the EDs start their transmissions simultaneously.

Step 6 (ES): Assuming that T_{PC,ES}=T_{RX,ED}+T_{PC,ED}−T_{Δ}and N_{ES}≥N_{UL}+[T_{Δ}/Tₛₐₘₚₗₑ], the RX DMA at the ES starts to transfer N_{ES} IQ samples (due to the request in Step 2) TΔ second before the EDs' transmissions, where Tₛₐₘₚₗₑ is the sample period. After executing read(N_{ES}), the ES receives the superposed signal starting from the [T₆₆/Tₛₐₘₚₗₑ] sample.

The procedure can be repeated after the ES waits for T_{wait,ES} seconds to allow the EDs to be ready for the next communication cycle and complete its own internal signal processing, where each cycle takes T_{PC,ED}+T_{RX,ED}+T_{TX,ED}+T_{wait,ES} seconds. Note that the parameters T_{PC,ED}, T_{RX,ED}, T_{TX,ED}, T_{PC,ES}, T_{Δ} and T_{wait,ES} can be pre-configured or configured online by the CC (e.g., through an advanced extensible interface (AXI)). Their values depend on the (slowest) processing speed of the constituent CCs in the network. The timers for T_{PC,ED}, T_{RX,ED}, T_{TX,ED}, and T_{PC,ES} can be implemented as counters that count up on each FPGA clock tick. The distinct feature of the disclosed block and the corresponding procedure is that the timers are set up via x_{SYNC} in the receive and transmit directions at both EDs and ES without using the CC.

### A. Synchronization Waveform Design and its Detection

The design of the synchronization waveform x_{SYNC} and its detection under carrier frequency offset (CFO) with limited FPGA resources were two major issues that we dealt with in our implementation. We address these challenges by synthesizing x_{SYNC} based on a single-carrier (SC) waveform with the roll-off factor of 0.5 by upsampling a repeated binary phase shift keying (BPSK) modulated sequence, i.e., 2[g g g g]−1, by a factor of Nᵤₚ=2 and passing it through a root-raised cosine (RRC) filter, where g=[g₁, . . . , g₃₂]∈ [symbol] ^{1×32} is a binary Golay sequence. As a result, the null-to-null bandwidth of x_{SYNC} is equal to 0.75 fₛₐₘₚₗₑ, where fₛₐₘₚₗₑ is the sample rate.

The rationale behind the design of x_{SYNC} is as follows:
1) An SC waveform with a low-order modulation has a small dynamic range. Hence, it requires less power back-off while it can be represented better after the quantization.
2) A cross-correlation operation can take a large number of FPGA resources due to the multiplications. However, the resulting waveform with the SC waveform with a large roll-off factor is similar to the SC waveform with a rectangular filter. Hence, we can approximately calculate the normalized cross-correlation by using its approximate SC waveform where its samples are either 1 or −1. Hence, the multiplications needed for the cross-correlation can be implemented with additions or subtractions.
3) In practice, x_{SYNC} is distorted due to the CFO. Hence, using a long sequence for cross-correlation can deteriorate the detection performance. To address this issue, we detect the presence of a shorter sequence, i.e., g, back to back four times to declare a detection (i.e., e_{det} [n]=1). We choose four repetitions as it provides a good trade-off between overhead and the detection performance. The metric that we use for the detection of g can be expressed as

$$m [ n ] {=}^{Δ} \frac{1}{{‖ b ‖}^{2}} \frac{{\vert ρ [ n ] \vert}^{2}}{{\vert r [ n ] \vert}^{2}} = \frac{1}{{‖ b ‖}^{2}} \frac{{〈 {s}_{n} , b 〉}^{2}}{{〈 {s}_{n} , {s}_{n} 〉}^{2}} = \frac{{〈 {s}_{n} , b 〉}^{2} / {2}^{12}}{{‖ {s}_{n} ‖}^{2}} \qquad ( 1 )$$

where b is based on the approximate SC waveform with the rectangular filter and equal to b=2[g₃₂, g₃₂, g₃₁, g₃₁, . . . , g₁, g₁]−1∈ [symbol] ^{1×64} for Nᵤₚ=2 and sₙ is [n−63], xᵣₓ [n−62], . . . , xᵣₓ [n]] for Mode 1 or [xₜₓ[n−63], xₜₓ[n−62], . . . , xₜₓ [n]] for Mode 2.

The block declares a detection if m[n] is larger than 1/4 for four times with 64 samples apart. Implemented IP is illustrated in FIG. 1(d), as referenced above.

### B. Addressing Inaccurate Clocks With Calibration Procedure

The baseband processing (and the additional processing for FEEL) at the ED can take time in the order of seconds. In this case, T_{PC} may need to be set to a large value accordingly. However, using a large value for T_{PC} (also for T_{RX} and T_{TX}) results in a surprising time offset problem due to the inaccurate and unstable FPGA clock. To elaborate on this, we model the instantaneous FPGA clock period T′clk,k [n] at the kth ED as T′_{clk,k} [n]=T_{clk}+ΔT_{clk,k}+n_{clk,k} [n] where T_{clk} is the ideal clock period and ΔT_{clk,k} and n_{clk,k} [n] are the offset and the jitter due to the imperfect oscillator on the SDR, respectively. The disclosed block at the kth ED measures T_{RX,ED}+T_{PC,ED} through a counter that counts up till N_{cnt}=(T_{RX,ED}+T_{PC,ED})/T_{clk} with the FPGA clock ticks. Therefore, the difference between T_{RX,ED}+T_{PC,ED} and the measured one can be calculated as

$$Δ {T}_{k} = {T}_{PC} - {\sum }_{n = 0}^{{N}_{cnt} - 1} {T}_{clk , k}^{′} [ n ] = {N}_{cnt} Δ {T}_{clk , k} + {\sum }_{n = 0}^{{N}_{cnt} - 1} {n}_{clk , k} [ n ] ,$$

which implies that a large N_{cnt} causes not only a large time offset (the first term) but also a large jitter (second term).

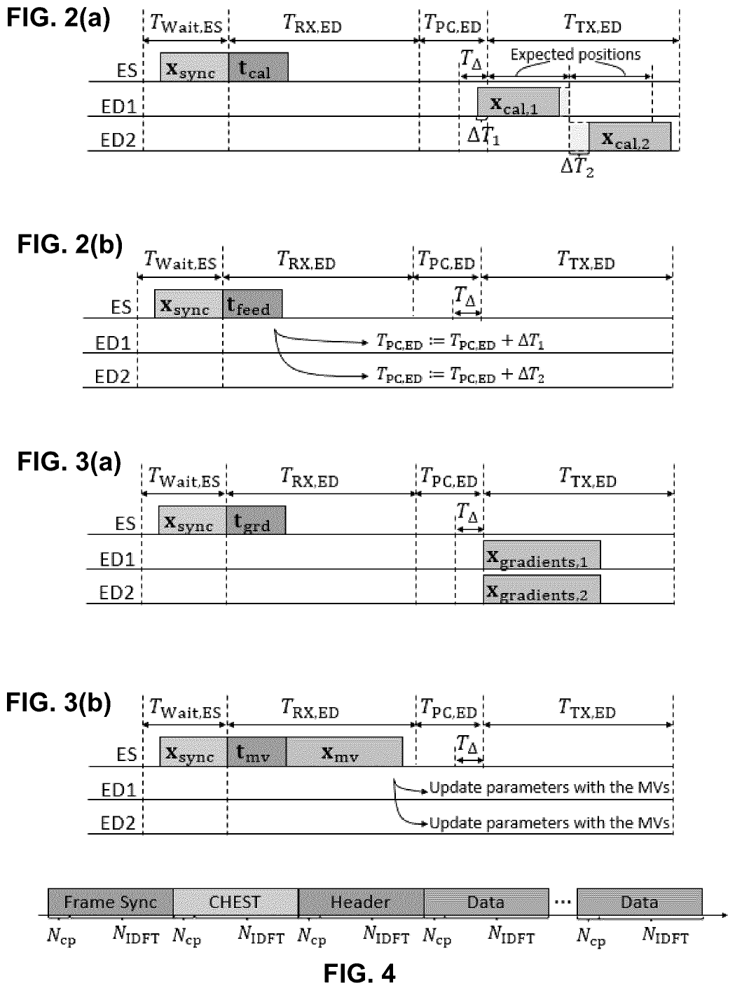

FIG. 2(a) represents an example of a timing chart illustrating an edge server (ES) transmitting a trigger signal, denoted by t_{cal}, along with x_{SYNC} as an aspect of a presently disclosed closed-loop calibration procedure. FIG. 2(b) represents an example of a timing chart illustrating an edge server (ES) transmitting a feedback signal denoted by t_{feed} as an aspect of a presently disclosed closed-loop calibration procedure.

The jitter can be mitigated by reducing N_{cnt} or using a more stable oscillator in the SDR. To address the time offset, we disclose a closed-loop calibration procedure as represented in conjunction with FIGS. 2(a) and 2(b). In this method, the ES transmits a trigger signal, denoted by t_{cal}, along with x_{SYNC} as shown in FIG. 2(a). After the kth ED receives t_{cal}, it responds to the trigger signal with a calibration signal, denoted by x_{cal,k}, ∀k, such that the received calibration signals are desired to be aligned back to back. With cross-correlations, the ES calculates ΔTₖ, ∀k. It then transmits a feedback signal denoted by t_{feed} as in FIG. 2(b), where t_{feed} contains time offset information for all EDs, i.e., {ΔTₖ, ∀k}. The feedback signal may be generalized to include information related received signal power, transmit power increment, or CFO. Subsequently, each ED updates its local T_{PC,ED} as T_{PC,ED}+ΔTₖ. In this portion of the disclosure, we construct t_{cal} based on a custom design, detailed in Section IV, while the calibration signals are based on Zadoff-Chu sequences.

### III. Disclosed OAC Procedure for FEEL

In this part of the disclosure, we implement FEEL based on the OAC scheme, i.e., FSK-MV, originally disclosed in [12] and extended in [13] with the absentee votes. To make the reader familiar with this scheme, let [symbol] ₖ denote the local data set containing the labeled data samples ( [symbol] , [symbol] ) at the kth ED for k=1 , . . . , K, where x [symbol] and y [symbol] are [symbol] th data sample and its associated label, respectively. The main problem tackled with FEEL can be expressed as

$${w}^{*} = arg {min}_{w} F ( w ) = arg {min}_{w} \frac{1}{\vert 𝒟 \vert} {\sum }_{∀ ( x , y ) ∈ ??} f ( w , x , y ) , \qquad ( 2 )$$

where [symbol] = [symbol] ₁ ∪ . . . ∪ [symbol] _{K} and f (w, x, y) is the sample loss function measuring the labeling error for (x, y) for the parameter vector w=[w1, . . . , w_{Q}]^{T}∈R^{Q}.

To solve (2) in a wireless network with OAC in a distributed manner (i.e., the global data set [symbol] cannot be formed by uploading the local data sets to the ES), for the nth parameter-update round, the kth ED first calculates the local stochastic gradients as

$${\tilde{g}}_{k}^{( n )} = ∇ {F}_{k} ( {w}^{( n )} ) = \frac{1}{{n}_{b}} {\sum }_{∀ ( {x}_{ℓ} , {y}_{ℓ} ) ∈ {\tilde{𝒟}}_{k}} ∇ f ( {w}^{( n )} , {x}_{ℓ} , {y}_{ℓ} ) , \qquad ( 3 )$$

where \tilde{g}ₖ⁽ⁿ⁾=[\tilde{g}_{k,1}⁽ⁿ⁾, . . . , \tilde{g}_{k,Q}⁽ⁿ⁾] is the gradient vector, [symbol] ₖ ⊂ [symbol] ₖ is the selected data batch from the local data set and n_{b}=| [symbol] ₖ| as the batch size.

Similar to the distributed training strategy by the MV with sign stochastic

gradient descent (signSGD) [14], each ED then activates one of the two subcarriers determined by the time-frequency index pairs (m+, l+) and (m−, l−) for m+, m−∈{0, 1, . . . , S−1} and l+, l−, l−∈{0, 1, . . . , M−1} with the symbols t_{k,l}_{⁺}, ₘ_{⁺}⁽ⁿ⁾ and t_{k,l}_{^{−}}, ₘ_{^{−}}⁽ⁿ⁾, ∀_{q} as and

t_{k,l}_{⁺},ₘ_{⁺}⁽ⁿ⁾=\sqrt{E_{S}}S_{k,q}⁽ⁿ⁾ω(\tilde{g}_{k,q}⁽ⁿ⁾) [symbol] [sign(\tilde{g}_{k,q}⁽ⁿ⁾)=1], (4)

and

t_{k,l}_{^{−}},ₘ_{^{−}}⁽ⁿ⁾=\sqrt{E_{S}}S_{k,q}⁽ⁿ⁾ω(\tilde{g}_{k,q}⁽ⁿ⁾) [symbol] [sign(\tilde{g}_{k,q}⁽ⁿ⁾)=−1], (5)

respectively, where ω(ĝ_{k,q}⁽ⁿ⁾=1 for |\tilde{g}_{k,q}⁽ⁿ⁾|≥ [symbol] , otherwise it is 0, Eₛ=2 is the normalization factor, S_{k,q}⁽ⁿ⁾ is a random quadrature phase-shift keying (QPSK) symbol to reduce the peak-to-mean envelope power ratio (PMEPR), the function sign (·) results in 1, −1, or ±1 at random for a positive, a negative, or a zero-valued argument, respectively, and the function [symbol] [·] results in 1 if its argument holds, otherwise it is 0.

The K EDs then access the wireless channel on the same time-frequency resources simultaneously with S orthogonal frequency division multiplexing (OFDM) symbols consisting of M active subcarriers. In [13], it is shown that [symbol] >0 (i.e., enabling absentee votes) can improve the test accuracy by eliminating the converging EDs from the MV calculation when the data distribution is heterogeneous.

Let r_{l+,m+}⁽ⁿ⁾ and r_{l-,m-}⁽ⁿ⁾ be the received symbols after the superposition for the q^{th} gradient at the ES. The ES detects the MV for the q^{th} gradient with an energy detector as

v_{q}⁽ⁿ⁾=sign (Δ_{q}⁽ⁿ⁾), (6)

where Δ_{q}⁽ⁿ⁾ [symbol] e_{q}⁺−e_{q}⁻for e_{q}⁺ [symbol] |rₗ_{^{+,}}ₘ_{⁺}⁽ⁿ⁾|₂² and e_{q}⁻ [symbol] rₗ_{^{+,}}ₘ_{⁺}⁽ⁿ⁾|₂², ∀q.

Finally, the ES transmits v⁽ⁿ⁾=[v₁⁽ⁿ⁾, . . . , v_{Q}⁽ⁿ⁾]^{T} to the EDs and the models at the EDs are updated as w⁽ⁿ⁺¹⁾=w⁽ⁿ⁾−ηv⁽ⁿ⁾, where η is the learning rate.

In [12] and [13], the reception of the MV vector by the EDs is assumed to be perfect. In practice, the MVs can be communicated via traditional communication methods. Nevertheless, as it increases the complexity of the EDs, we also use the FSK in the DL in our implementation as done for the UL.

FIG. 3(a) represents an example of a timing chart illustrating the kth edge devices (EDs) responding to the received t_{grd} with X_{gradients,k}, ∀k, as an aspect of a presently disclosed procedure for frequency-shift keying (FSK)-based majority vote (MV) (FSK-MV) processing. FIG. 3(b) represents an example of a timing chart illustrating the kth edge devices (EDs) transmitting xₘᵥ along with tₘᵥ as an aspect of a presently disclosed procedure for frequency-shift keying (FSK)-based majority vote (MV) (FSK-MV) processing.

In FIGS. 3(a) and 3(b), we illustrate the disclosed procedure for FSK-MV. Assuming that the calibration is done via the procedure in Section II-B, the ES initiates the OAC by transmitting a trigger signal, i.e., t_{grd}, along with the synchronization waveform. The kth EDs responds to the received t_{grd} with X_{gradients,k}, ∀k, i.e., the IQ samples calculated based on (4) and (5). After the ES receives the superposed modulation symbols, it calculates the MVs with (6), ∀q. After it synthesizes the IQ samples consisting the OFDM symbols based on FSK, i.e., xₘᵥ, it transmits xₘᵥ along with tmv as shown in FIG. 3(b). Each ED decodes tₘᵥ to detect the following samples include the MVs. After decoding the received xₘᵥ, each ED updates its model parameters. Similar to t_{cal} and t_{feed}, the signals t_{grd} and tₘᵥ are based on the physical layer protocol data unit (PPDU) discussed in Section IV.

### IV. Disclosed PPDU for Signaling

The signaling between EDs and ES in this disclosure is maintained over a custom PPDU as shown in FIG. 4, and the signal occurs through bits transmitted through the PPDU. FIG. 4 represents different fields used for a presently disclosed physical layer protocol data unit (PPDU) for signaling between EDs and ES. In other words, FIG. 4 illustrates the structure of the disclosed PPDU for t_{cal}, t_{feed}, t_{grd}, tₘᵥ.

In this design, there are four different fields, i.e., frame synchronization, channel estimation (CHEST), header, and data fields, where each field is based on OFDM symbols. We express an OFDM symbol as

t=AF_{N}_{_{IDFT}}^{H}M_{f}d, (7)

where A ∈ [symbol] ^{N}^{_{IDFT}}+^{N}^{_{cp}}×^{N}^{_{IDFT}} is the cyclic prefix (CP) addition matrix, F_{N}_{_{IDFT}}^{H}∈ [symbol] ^{N}^{_{IDFT}}×^{N}^{_{IDFT}} is the normalized NIDFT-point inverse DFT (IDFT) matrix (i.e., F_{N}_{_{IDFT}}^{H}F_{N}_{_{IDFT}}=I_{N}_{_{IDFT}}), M_{f}∈ [symbol] ^{N}^{_{IDFT}}^{×M} is the mapping matrix that maps the modulation symbols to the subcarriers, and d ∈C^{M×1} contains the modulation symbols on M subcarriers.

For all fields, we set the IDFT size and CP size for synthesizing the OFDM symbols to N_{IDFT}=256 and N_{cp}=64, respectively. For CHEST, header, and data fields, we use M=192 active subcarriers along with 8 direct current (DC) subcarriers. For the frame synchronization field, the DC subcarriers are also utilized.

### A. Frame Synchronization Field

The frame synchronization field is a single OFDM symbol. Every other active subcarrier within the band is utilized with a Zadoff-Chu sequence of length 97. Therefore, the corresponding OFDM symbols has two repetitions in the time domain. While the repetitions are used to estimate the CFO at the receiver, the null subcarriers are utilized to estimate the noise variance.

### B. CHEST Field

The CHEST field is a single OFDM symbol. The modulation symbols are the elements of a pair of QPSK Golay sequences of length 96, denoted by (gₐ, g_{b}). The d is the concatenation of gₐ and g_{b}.

### C. Header Field

The header is a single OFDM symbol. It is based on BPSK symbols with a polar code of length 128 with the rate of 1/2. We reserve 56 bits for a sequence of signature bits, the number of codewords in the data field, i.e., N_{cw}, and the number of pre-padding bits, i.e., N_{pad}. The rest of the 8 bits are reserved for cyclic redundancy check (CRC). We also use QPSK-based phase tracking symbols for every other two subcarriers, where the tracking symbols are the elements of a QPSK Golay sequence of length 64.

### D. Data Field

Let N_{bit} be the number of information bits to be communicated. We calculate the number of codewords and the number of pre-padding bits as N_{cw}=[N_{bit}/56] and N_{pad}=56N_{cw}−N_{bit}. After the information bits are padded with N_{pad}, they are grouped into N_{cw} messages of length 56 bits. The concentration of each message sequence and its corresponding CRC is encoded with a polar code of length 128 with the rate of 1/2. We carry one codeword on each OFDM symbol with BPSK modulation. Hence, the number of OFDM symbols in the data field is also N_{cw}. Similar to the header, QPSK-based phase tracking symbols are used for every other two subcarriers.

### E. Signaling

Throughout this disclosure, we use the information bits that are transmitted over the PPDU to signal t_{cal}, t_{feed}, t_{grd}, tₘᵥ and user multiplexing. We dedicate 4 bits for signaling type and 25 bits for user multiplexing. If the signaling type is the calibration feedback, we define 32 bits for time offset and 8 bits for power control for each ED.

### V. Experiment

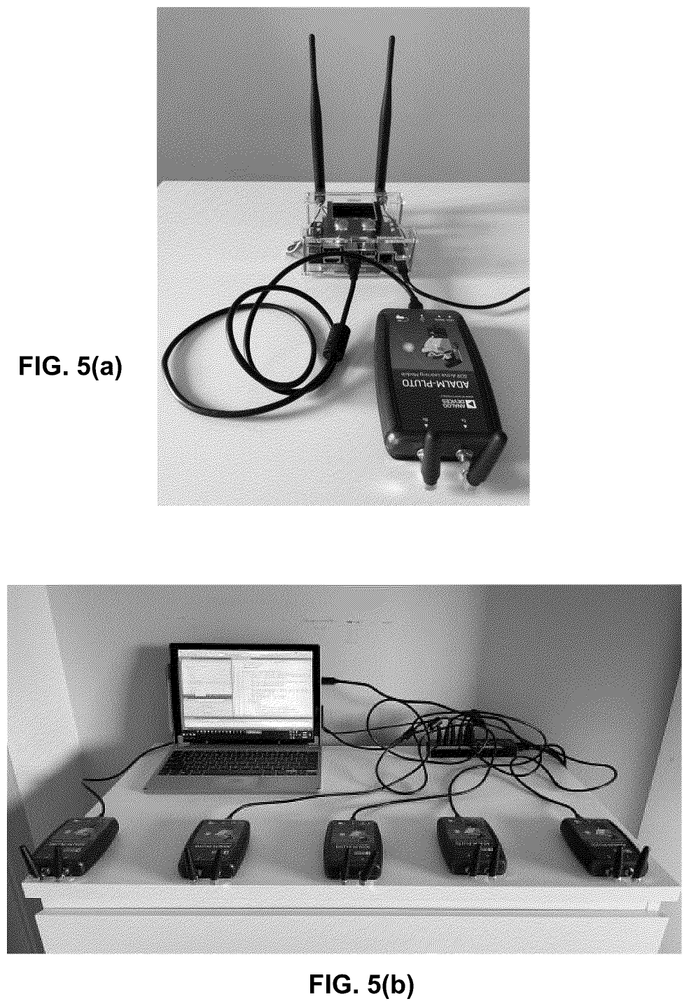

For the experiment/confirmation, we consider the learning task of handwritten-digit recognition with K=5 EDs and ES, where each of them is implemented with Adalm Pluto (Rev. C) SDRs. FIGS. 5(a) and 5(b) are respective images of an exemplary experimental/confirmation set-up for practicing the presently disclosed subject matter for an exemplary learning task of handwritten-digit recognition with K=5 EDs and ES, where the exemplary arrangement is implemented with an NVIDIA Jetson Nano, a Microsoft Surface Pro 4, and six Analog Device Adalm Pluto software-defined radios (SDRs) for FEEL. FIG. 5(a) shows an image of the ES with an NVIDIA Jetson Nano. FIG. 5(b) shows an image of the five EDs with a Microsoft Surface Pro 4, and with an independent thread run for each SDR.

We develop the IP core for the disclosed synchronization method by using MATLAB HDL Coder and embed it to the FPGA (Xilinx Zynq XC7Z010) based on the guidelines provided in [15]. As shown in FIGS. 5(a) and 5(b), we use a Microsoft Surface Pro 4 for the EDs, where an independent thread runs for each ED. The CC for the ES is an NVIDIA Jetson Nano development module. The baseband and machine learning algorithms are written in the Python language. We run the experiment in an indoor environment where the mobility is relatively low. The link distance between an ED and the ES is approximately 5 m. The sample rate is fₛₐₘₚₗₑ=20 Msps for all radios and the signal bandwidth is approximately 15 MHz. We synthesize the vectors t_{cal}, t_{feed}, t_{grd}, tₘᵥ based on the custom PPDU discussed in Section IV and consider the same OFDM symbol structure in the PPDU for xₘᵥ X_{gradients,k}, and X_{cal,k}, ∀k. For the synchronization IP, the pre-configured values of T_{wait,ES}, T_{PC,ED}, T_{RX,ED}, T_{TX,ED}, and T_{Δ} are 750 ms, 750 ms, 50 ms, 50 ms, and 100 μs, respectively.

We use the MNIST database that contains labeled handwritten-digit images. To prepare the data, we first choose |D|=25000 training images from the database, where each digit has distinct 2500 images. For homogeneous data distribution, each ED has 500 distinct images for each digit. For heterogeneous data distribution, kth ED has the data samples with the labels {k−1, k, 1+k, 2+k, 3+k, 4+k}. For both distributions, the EDs do not have common training images. For the model, we consider a convolution neural network (CNN) that consists of two 2D convolutional layers with the kernel size [5, 5], stride [1, 1], and padding [2, 2], where the former layer has 1 input and 16 output channels and the latter one has 16 input and 32 output channels. Each layer is followed by batch norm, rectified linear units, and max pooling layer with the kernel size 2. Finally, we use a fully-connected layer followed by softmax. Our model has Q=29034 learnable parameters that result in S=303 OFDM symbols for FSK-MV. We set η=0.001 and n_{b}=100. For the test accuracy, we use 10000 test samples in the database.

The experiment reveals many practical issues. The FPGA clock rate of Adalm Pluto SDR is 100 MHz, generated from a 40 MHz oscillator where the frequency deviation is rated at 20 PPM. Due to the large deviation and T_{PC,ED}+T_{RX,ED}, we observe a large time offset and a large jitter as discussed in Section II-B. Hence, the ES initiates the calibration procedure in FIG. 2 after completing the OAC procedure in FIG. 3, sequentially.

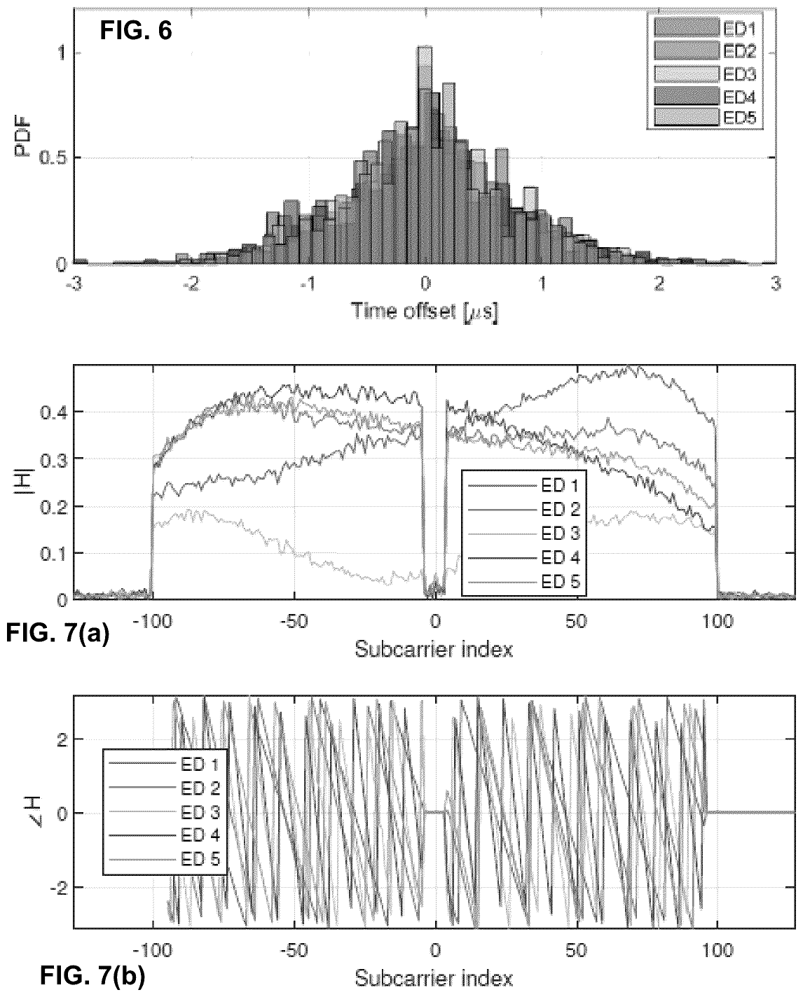

FIG. 6 illustrates a bar graph of the distribution of time synchronization error due to the imperfect clocks in Adalm Pluto SDRs (ED1 through ED5).

In FIG. 6, we provide the distribution of the jitter after the calibration, where the standard deviation of the jitter is around 1 μs for T_{PC,ED}+T_{RX,ED}=0.8 s. Although the jitter can be considerably large, we conduct the experiment under this impairment to demonstrate the robustness of FSK-MV against synchronization errors. In the experiment, a line-of-sight path is present. Nevertheless, the channel between an ED and the ES is still frequency selective as can be seen in FIGS. 7(a) and 7(b).

FIG. 7(a) graphically illustrates subcarrier index data to illustrate magnitudes of the channel frequency coefficients, between an ED and the ES, per absolute values. FIG. 7(b) graphically illustrates subcarrier index data to illustrate magnitudes of the channel frequency coefficients (channel frequency response), between an ED and the ES, per phase changes.

In the experiment, we observe that the magnitudes of the channel frequency coefficients do not change significantly due to the low mobility. However, their phases change in an intractable manner due to the random time offsets. Nevertheless, this is not an issue for FSK-MV as it does not require a phase alignment. Note that we also implement a closed-loop power control by using the calibration procedure to align the received signal powers. However, an ideal power alignment is challenging to maintain. For example, ED 3's channel in FIG. 7 is relatively under a deep fade, but the SDR's transmit power cannot be increased further. Similar to the jitter, we run the experiment under non-ideal power control.

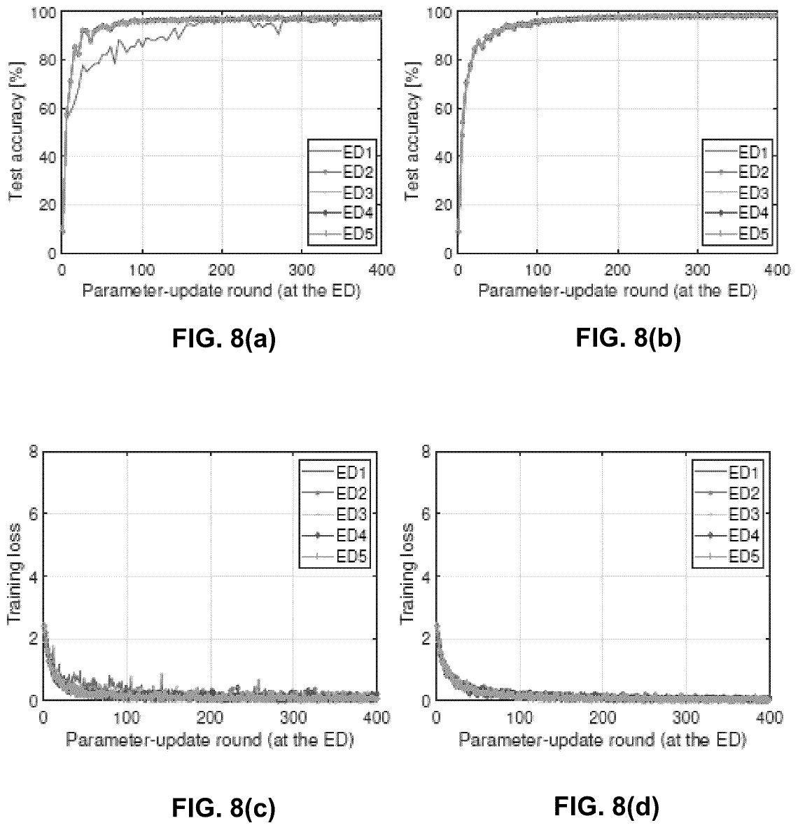

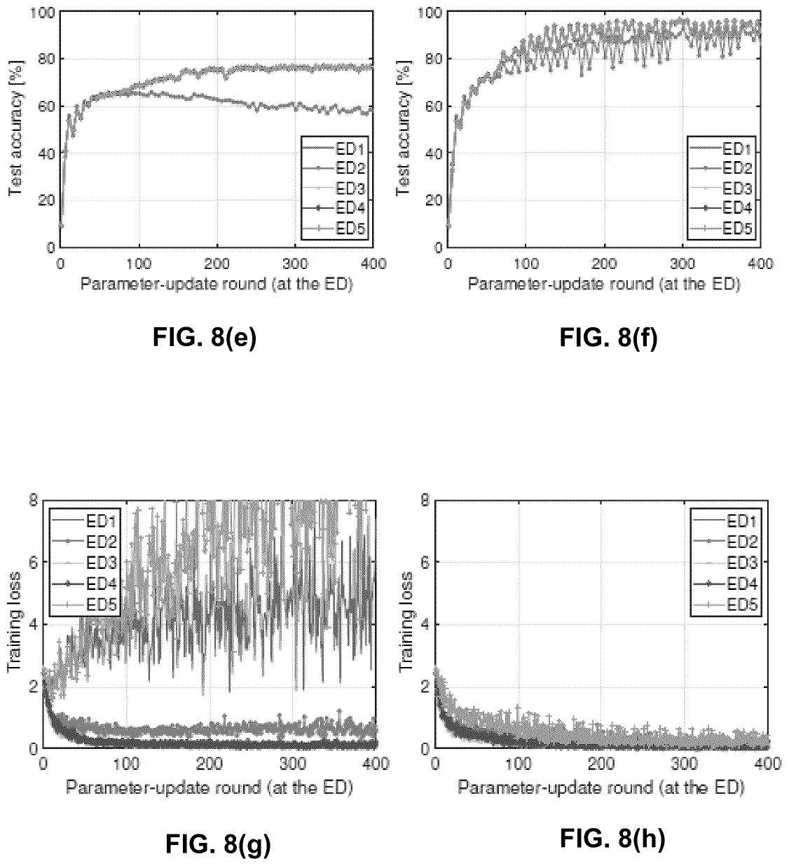

Finally, FIGS. 8(a)-8(h) respectively graphically represent test accuracy and training loss at each ED when the training is done without absentee votes ( [symbol] =0) and with absentee votes ( [symbol] =0.005), representing experiment results for the FEEL with the OAC scheme FSK-MV with/without absentee votes.

In particular, FIG. 8(a) graphs test accuracy for homogeneous data distribution without absentee votes, with FIG. 8(b) graphing test accuracy for homogeneous data distribution with absentee votes, with FIG. 8(c) graphing training loss for homogeneous data distribution without absentee votes, and with FIG. 8(d) graphing training loss for homogeneous data distribution with absentee votes.

Further, FIG. 8(e) graphs test accuracy for heterogeneous data distribution without absentee votes, with FIG. 8(f) graphing test accuracy for heterogeneous data distribution with absentee votes, with FIG. 8(g) graphing training loss for heterogeneous data distribution without absentee votes, and with FIG. 8(h) graphing training loss for heterogeneous data distribution with absentee votes.

For homogeneous data distribution, the test accuracy for each ED quickly reaches 97.5% for both cases as given in FIG. 8(a) and FIG. 8(b). The corresponding training losses also decrease as shown in FIG. 8(c) and FIG. 8(d). For heterogeneous data distribution scenario, eliminating converging ED improves the test accuracy considerably. For example, in FIG. 8(g), the training losses for ED 1 and ED 5 gradually increase, which indicates that the digit 0 and the digit 9 cannot be learned well since these images are available at ED 1 and ED 5. Therefore, the test accuracy drops below 80% as shown in FIG. 8(e). However, with absentee votes, this issue is largely addressed and test accuracy reaches 95% as can be seen in FIG. 8(f).

### VI. Conclusion

We disclose a method that can maintain the synchronization in an SDR-based network without implementing the baseband as a hard-coded block. We also provide the corresponding procedure and discuss the design of the synchronization waveform to address the hardware limitations. Finally, by implementing the disclosed concept with Adalm Pluto SDRs, for the first time, we demonstrate the performance of an OAC, i.e., FSK-MV, for FEEL. Our experiment shows that FSK-MV provides robustness against time synchronization errors and can result in a high test accuracy in practice.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims.

### REFERENCES

[1]. M. Goldenbaum, H. Boche, and S. Stańczak, “Nomographic functions: Efficient computation in clustered gaussian sensor networks,” IEEE Trans. Wireless Commun., vol. 14, no. 4, pp. 2093-2105, 2015.
[2]. G. Zhu, Y. Du, D. Gündüz, and K. Huang, “One-bit over-the-air aggregation for communication-efficient federated edge learning: Design and convergence analysis,” IEEE Trans. Wireless Commun., vol. 20, no. 3, pp. 2120-2135, Nov. 2021.
[3]. P. Liu, J. Jiang, G. Zhu, L. Cheng, W. Jiang, W. Luo, Y. Du, and Z. Wang, “Training time minimization for federated edge learning with optimized gradient quantization and bandwidth allocation,” 2021. [Online]. Available: https://arxiv.org/abs/2112.14387
[4]. U. Altun, G. K. Kurt, and E. Ozdemir, “The magic of superposition: A survey on simultaneous transmission based wireless systems,” 2021. [Online]. Available: https://arxiv.org/abs/2102.13144
[5]. K. Alemdar, D. Varshney, S. Mohanti, U. Muncuk, and K. Chowdhury, “RFClock: Timing, phase and frequency synchronization for distributed wireless networks,” in Proc. International Conference on Mobile Computing and Networking (MobiCom), 2021, p. 15-27.
[6]. B. Bellalta and K. Kosek-Szott, “AP-initiated multi-user transmissions in IEEE 802.11ax WLANs,” Ad Hoc Networks, vol. 85, pp. 145-159, 2019.
[7]. E. Dahlman, S Parkvall, and J. Skold, 5G NR: The Next Generation Wireless Access Technology, 1st ed. USA: Academic Press, Inc., 2018.
[8]. P. Jakimovski, F. Becker, S. Sigg, H. R. Schmidtke, and M. Beigl, “Collective communication for dense sensing environments,” in Proc. IEEE Intelligent Environments, 2011, pp. 157-164.
[9]. Kortke, M. Goldenbaum, and S. Stańczak, “Analog computation over the wireless channel: A proof of concept,” in Proc. IEEE Sensors, 2014, pp. 1224-1227.
[10]. M. Goldenbaum and S. Stańczak, “Robust analog function computation via wireless multiple-access channels,” IEEE Trans. Commun., vol. 61, no. 9, pp. 3863-3877, 2013.
[11]. U. Altun, S. T. Bas,aran, H. Alakoca, and G. K. Kurt, “A testbed based verification of joint communication and computation systems,” in Proc. IEEE Telecommunication Forum (TELFOR), 2017, pp. 1-4.
[12]. A. Şahin, B. Everette, and S. Hoque, “Distributed learning over a wireless network with FSK-based majority vote,” in Proc. IEEEE International Conference on Advanced Communication Technologies and Networking (CommNet), Dec. 2021, pp. 1-9.
[13]. A Şahin, “Distributed learning over a wireless network with non- coherent majority vote computation,” IEEE Trans. Wireless Commun., 2022 (under review).
[14]. J. Bernstein, Y.-X. Wang, K. Azizzadenesheli, and A. Anandkumar, “signSGD: Compressed optimisation for non-convex problems,” in Proc. in International Conference on Machine Learning, vol. 80. Proceedings of Machine Learning Research, 10-15 Jul. 2018, pp. 560-569.
[15]. Analog Device, “plutosdr-fw, v34,” 2022. [Online]. Available: https.//github.com/analogdevicesinc/plutosdr-fw.git

What is claimed is:

1. An over-the-air computation (OAC) methodology for federated edge learning (FEEL) without using channel state information (CSI) at a plurality of edge devices (EDs) or at an edge server (ES), comprising:
a distributed machine-learning model to be trained with the update vectors received at an edge server (ES) as transmitted from a plurality of edge devices (EDs);
one or more processors; and
one or more non-transitory computer-readable media that store instructions that, when executed by the one or more processors, cause the one or more processors to perform operations, the operations comprising:
transmitting local update vectors as votes from each respective of the plurality of edge devices (EDs) via a wireless multiple access channel,
receiving the superposed local updates at the ES,
determining the majority vote (MV) for each element of the update vector at the ES with an energy detector, and
inputting the MVs into the machine-learning model to be updated,
wherein the plurality of EDs and the ES each respectively comprise a software-defined radio (SDR) using a general purpose synchronization method between the ES and each respective ED which relies on the detection of a synchronization waveform in both receive and transmit directions.

2. The over-the-air computation (OAC) methodology according to claim 1, wherein:
implementation of each ED and the ES is based on respective SDRs where the baseband processing for each is handled by a respective companion computer (CC) for each SDR; and
the synchronization waveform is the same in both receive and transmit directions, which allows the SDRs to transmit or receive any in-phase/quadrature (IQ) data with precise timings.

3. The over-the-air computation (OAC) methodology according to claim 2, further comprising using a hard-coded block that is solely responsible for time synchronization among the EDs and ES, and which jointly controls the transmitter (TX) direct-memory access (DMA) and the receiver (RX) DMA of the SDRs with the processing systems (PS) of the respective SDRs, as a function of the detection of the synchronization waveform (x_{SYNC}) in the transmit or receive directions.

4. The over-the-air computation (OAC) methodology according to claim 3, further comprising using TX DMA and RX DMA for transferring the IQ data between the random access memory (RAM) and a transceiver block.

5. The over-the-air computation (OAC) methodology according to claim 4, wherein the hard-coded block has two respective modes of operation:
(1) mode 1 where the TX DMA and RX DMA cannot transfer the IQ data, and
(2) mode 2 where the TX DMA and RX DMA can transfer the IQ data.

6. The over-the-air computation (OAC) methodology according to claim 5, wherein during mode 1, the hard-coded block listens to the output of the transceiver block to search for the synchronization waveform x_{SYNC}, and if x_{SYNC} is detected, the hard-coded block sequentially sets a time to allow the RX DMA to move the received IQ data to the RAM, and sets another time to subsequently allow TX DMA to transfer the IQ data from the RAM to the transceiver block.

7. The over-the-air computation (OAC) methodology according to claim 6, wherein during mode 2, the hard-coded block listens to the output of the TX DMA to search for the synchronization waveform x_{SYNC}, and if x_{SYNC} is detected, the hard-coded block prevents reception by the RX DMA.

8. The over-the-air computation (OAC) methodology according to claim 3, wherein the hard-coded block controls time synchronization among the ES and the EDs to perform sequential communication cycles using timers which are set up via the synchronization waveform x_{SYNC} in the receive and transmit directions at both EDs and ES without using the CCs.

9. The over-the-air computation (OAC) methodology according to claim 2, wherein the synchronization waveform (x_{SYNC}) is synthesized based on a single-carrier (SC) waveform by upsampling a repeated binary phase shift keying (BPSK) modulated sequence, and passing it through filter.

10. The over-the-air computation (OAC) methodology according to claim 9, wherein the filter comprises a root-raised cosine (RRC) filter, and the null-to-null bandwidth of x_{SYNC} is equal to 0.75 fₛₐₘₚₗₑ, where fₛₐₘₚₗₑ is the sample rate.

11. The over-the-air computation (OAC) methodology according to claim 1, wherein detection of a synchronization waveform is determined based on detecting the presence of the synchronization waveform back to back for a predetermined minimum number of times to declare a detection.

12. The over-the-air computation (OAC) methodology according to claim 1, wherein the synchronization method between the ES and each respective ED further comprises a closed-loop calibration procedure for coordinating the clocks of each ED and the ES.

13. The over-the-air computation (OAC) methodology according to claim 12, wherein the closed-loop calibration procedure comprises:
(1) the edge server (ES) transmits a trigger signal along with the synchronization waveform,
(2) after the kth ED receives the trigger signal, each ED responds to the trigger signal with a calibration signal such that the received calibration signals are to be aligned back to back,
(3) the ES transmits a feedback signal with time offset information for all EDs, and
(4) each ED updates its local clock information based on the feedback signal.

14. The over-the-air computation (OAC) methodology according to claim 13, wherein the feedback signal further includes information related to at least one of received signal power, transmit power increment, or carrier frequency offset (CFO).

15. The over-the-air computation (OAC) methodology according to claim 1, wherein signaling between EDs and ES is maintained over a physical layer protocol data unit (PPDU) having a plurality of different fields, and with signals occurring through bits transmitted through the PPDU

16. The over-the-air computation (OAC) methodology according to claim 15, wherein the plurality of different fields for the PPDU comprise at least four different fields including frame synchronization, channel estimation (CHEST), header, and data fields, and where each field is based on orthogonal frequency division multiplexing (OFDM) symbols.

17. The over-the-air computation (OAC) methodology according to claim 1, wherein:
determining the majority vote (MV) for each element of the update vector at the ES comprises determining with an energy detector over orthogonal time and frequency resources; and
transmitting local update vectors comprises transmitting local update vectors as weighted votes over selected multiple orthogonal subcarriers grouped based on the sign of the elements of the update vector from each respective of the plurality of edge devices (EDs) via a wireless multiple access channel.

18. The over-the-air computation (OAC) methodology according to claim 1, wherein the votes comprise (1) pulse-position modulation (PPM) symbols constructed with discrete Fourier transform (DFT)-spread orthogonal frequency division multiplexing (OFDM) (DFT-s-OFDM) or (2) frequency-shift keying (FSK) symbols constructed with orthogonal frequency division multiplexing (OFDM) for voting options.

19. An over-the-air computation (OAC) system for federated edge learning (FEEL) without using channel state information (CSI) at a plurality of edge devices (EDs) or at an edge server (ES), comprising:
a machine-learning model training to process data received at an edge server (ES) as transmitted from a plurality of edge devices (EDs);
one or more processors; and
one or more non-transitory computer-readable media that store instructions that, when executed by the one or more processors, cause the one or more processors to perform operations, the operations comprising:
transmitting local update vectors as votes from each respective of the plurality of edge devices (EDs) via a wireless multiple access channel,
receiving the superposed local updates at the ES,
determining the majority vote (MV) for each element of the update vector at the ES with an energy detector, and
inputting the MVs into the machine-learning model to be updated,
wherein the plurality of EDs and the ES each respectively comprise a software-defined radio (SDR) using a general purpose synchronization method between the ES and each respective ED which relies on the detection of a synchronization waveform in both receive and transmit directions.

20. The over-the-air computation (OAC) system according to claim 19, wherein:
each ED and the ES is based on respective SDRs each having an associated respective companion computer (CC) for handling baseband processing for its respective associated SDR; and
the synchronization waveform is the same in both receive and transmit directions, so that the SDRs to transmit or receive any in-phase/quadrature (IQ) data with precise timings.

21. The over-the-air computation (OAC) system according to claim 20, further comprising a hard-coded processing block programmed for handling time synchronization among the EDs and ES, and for controlling the transmitter (TX) direct-memory access (DMA) and the receiver (RX) DMA of the SDRs as a function of the detection of the synchronization waveform (x_{SYNC}) in the transmit or receive directions.

22. The over-the-air computation (OAC) system according to claim 21, further comprising:
a random access memory (RAM) and a transceiver processing block; and
wherein the instructions further cause the one or more processors to perform further operations, comprising using the TX DMA and RX DMA for transferring the IQ data between the random access memory (RAM) and a transceiver block; and
the hard-coded processing block is further programmed for two respective modes of operation:
(1) mode 1 where the TX DMA and RX DMA cannot transfer the IQ data, and
(2) mode 2 where the TX DMA and RX DMA can transfer the IQ data.

23. The over-the-air computation (OAC) system according to claim 21, wherein:
during mode 1, the hard-coded processing block is further programmed to listen to the output of the transceiver processing block to search for the synchronization waveform x_{SYNC}, and if x_{SYNC} is detected, to sequentially sets a time to allow the RX DMA to move the received IQ data to the RAM, and to set another time to subsequently allow TX DMA to transfer the IQ data from the RAM to the transceiver processing block; and
during mode 2, the hard-coded processing block is further programmed to listen to the output of the TX DMA to search for the synchronization waveform x_{SYNC}, and if xsyNc is detected, to prevent reception by the RX DMA.

24. The over-the-air computation (OAC) system according to claim 21, wherein the hard-coded processing block is further programmed for controlling time synchronization among the ES and the EDs to perform sequential communication cycles using timers which are set up via the synchronization waveform x_{SYNC} in the receive and transmit directions at both EDs and ES without using the CCs.

25. The over-the-air computation (OAC) system according to claim 19, wherein the synchronization method between the ES and each respective ED further comprises:
a closed-loop calibration procedure for coordinating the clocks of each ED and the ES, and
detection of a synchronization waveform is determined based on detecting the presence of the synchronization waveform back to back for a predetermined minimum number of times to declare a detection.

26. The over-the-air computation (OAC) system according to claim 19, wherein the SDRs are programmed for maintaining communications over a physical layer protocol data unit (PPDU) having a plurality of different fields, comprising at least four different fields including frame synchronization, channel estimation (CHEST), header, and data fields, and where each field is based on orthogonal frequency division multiplexing (OFDM) symbols.
